(19) United States
(12) Patent Application Publication
(10) Pub. No.: US 2004/0079468 A1
(43) Pub. Date: Apr. 29, 2004

(54) Process for producing carpet

(76) Inventors: Raymond Joseph Reisdorf, Nobressart (BE); Loic Pierre Rolland, Divonne (FR)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/658,084

(22) Filed: Sep. 9, 2003

Related U.S. Application Data
(60) Provisional application No. 60/410,767, filed on Sep. 13, 2002.

(51) Int. Cl. B32B 31/00

(52) U.S. Cl. 156/72

(57) ABSTRACT

A process for preparation of a tufted polyamide-type fiber carpet is provided. A primary backing tufted with yarn comprised of at least 85% by weight of fibers selected from the group nylon fibers, wool fibers, and blends thereof is provided. A molten polymer adhesive is provided on the back side of the tufted primary backing, the polymer adhesive consisting of at least 85% by weight of one or more ethylene copolymers each comprised of 50 to 95 weight % of ethylene, and 5-50 weight % of at least one comonomer selected from the group of esters and carboxylic acids. The tufted primary backing and the molten polymer adhesive layer are compressed under a moving belt that applies a pressure of at least 1 N/cm² for a period of at least 5 seconds during which time the polymer adhesive remains in a molten state. The molten polymer adhesive then cooled to a temperature below the melting point of said molten adhesive. A secondary backing may be placed over the molten polymer adhesive on the back of the primary backing.

### BACKGROUND OF THE INVENTION

The present invention relates to carpets and to processes for manufacturing carpets using an extrusion coating process with a thermoplastic adhesive binder. More particularly, the invention relates to processes for producing tufted carpets that exhibit improved pile fiber retention under conditions of abrasive wear.

Manufacture of tufted carpets normally involves tufting dyed or undyed face yarns into a primary backing. The yarns can be prepared from a variety of materials including natural fibers such as wool or cotton, or synthetic fibers spun from polymers including nylons, polyesters, acrylics and polyolefins. Of these, nylon 66 and nylon 6 are the dominant materials in view of their overall balance of aesthetics, cost and performance in use. The tufting operation is described in detail in U.S. Pat. No. 4,844,765, at column 1, lines 19-43, which is incorporated by reference. If the face yarn is undyed, the tufted primary backing is next printed or piece dyed in either a batch or continuous operation. After dyeing, the carpet is washed and dried and usually prepared for application of a secondary backing on the back side of the tufted primary backing. The secondary backing is usually a woven or nonwoven polypropylene or polyester synthetic fabric or a woven jute natural fabric.

The application of the secondary backing as part of the carpet finishing operation has traditionally involved application of a significant quantity of an aqueous latex binder, which typically includes a substantial amount of filler. These latex binders have dominated the industry for many years because of their ability to provide good wetability and good adhesive performance at low cost. In the conventional latex process, a preliminary latex coating (“a precoat”) is first applied to the back of the tufted primary backing in order to fix the fibers in the primary backing. Once this precoat has been dried in an oven, an adhesive latex binder layer and a secondary textile backing are normally applied to the primary backing, after which the latex binder is dried and vulcanized in a dryer. Alternatively, a latex foam may be applied directly to the primary backing in place of the secondary textile backing. A widely used material for the latex adhesive binder is a carboxylated styrene butadiene rubber (XSBR).

There are both process and environmental disadvantages to using aqueous latex binders in the carpet making process. This latex process requires significant drying steps to remove water from the latex and then to set the latex. The drying steps limit production speed and increase the cost of the carpet, especially when thick needlepunched secondary backings are used. This is particularly acute when energy costs rise. Additionally, dryers represent a major capital investment. Carpets made with latex binders also have the disadvantage that they are pervious to water and that they even retain water which makes cleaning such carpets difficult. Additionally, the latex is very difficult to recycle and it generates odors during the process of heating, as may occur during carpet installation.

Accordingly, there has been a long felt need for a process for making durable carpets that use thermoplastic adhesive binders instead of latex binders and there have been attempts to develop carpets made with thermoplastic binders. Bailey, et.al, WO 96/29460A1, pp. 5-8 provides a summary of thermoplastic adhesives that have been considered for finishing tufted carpets. WO 96/29460A1 is directed to a tufted carpet bonded with an adhesive binder that includes a thermoplastic resin and is substantially free of inorganic and latex materials, which carpet exhibits good tuft bind. This publication refers to a test method (ASTM D-1335) for measuring resistance against a whole tuft being pulled from a carpet when snagged, as can occur with loop pile carpets.

Vinod, et.al., WO95/14806, discloses a process for making a tufted nylon or polyester pile carpet where a thermoplastic resin consisting essentially of an ethylene terpolymer having at least 8% by weight ester groups and at least 1% by weight carboxylic acid groups is contacted with a primary carpet backing having nylon or polyester yarn tufts contained therein. Tuft bind strengths of 4-5.5 lbs. (18-25 Newtons), as measured by the ASTM D-1335, are reported.

There is still a need for a commercially acceptable process for producing carpets using thermoplastic adhesive binders which carpets resist fiber loss. Extensive foot traffic, rolling of chair casters and sliding furniture and equipment over cut and loop pile carpets has been found to result in loss of pile fibers from the carpet by abrasive wear that works individual fibers out of the tuft without the entire tuft necessarily being pulled from the carpet. This is a particularly acute problem for short pile height velour carpets which are made primarily using nylon face fibers. There is little entanglement of the individual fibers with each other in the yarn bundle and consequently, unless the binder adhesive contacts essentially all of the individual fibers, binds the fibers, and remains intact under conditions of abrasive wear, then an unacceptably high proportion of the fibers are likely to be abraded out of the carpet leaving unsightly thin spots as well as undesirable contamination of the carpet surface with loose fibers. Where a carpet has a visual design or pattern, the loss of 15 to 20 percent of the carpet yarn fibers results in a substantial deterioration of the carpet's visual appearance.

A test for measuring pile fiber retention that focuses on the abrasive wear commonly experienced in commercial environments is the Lisson Tretrad test, Draft International Standard ISO/DIS 12951-1, which is described in the Test Method section below. The Lisson Tretrad test simulates the abrasive wear that a carpet will experience in a commercial environment where rolling of chair casters over the carpet, heavy foot traffic on the carpet, and sliding furniture and equipment over the carpet are regular events. This Lisson Tretrad test enables one to differentiate the level of effective fiber bind and encapsulation based on cumulative loss of pile fibers, as opposed to the ASTM D-1335 which only measures the force required to completely remove a tuft bundle from the backing. It has been found that there is little correlation between the loss of complete carpet tufts, as measured by ASTM-D-1335, and the loss of carpet fibers under conditions of abrasive wear, as measured by the Lisson Tretrad test ISO 12951-1. For example, Comparative Example 2 below shows a carpet with a satisfactory D-1335 tuft bind of greater than 9 Newtons that still exhibited an unsatisfactory 58% loss of pile fiber under the Lisson Tretrad test.

There is a need for an efficient process for producing carpets made with polyamide-type face fibers, such as wool or nylon fibers, and a thermoplastic adhesive binder which carpets are suitable for use in high wear commercial environments such as business offices. The carpet preparation process needs to ensure sufficient contact with the carpet fibers by the binder and good adhesion of substantially all the individual fibers in the tufts so as to hold the carpet fibers in place. Of course, other necessary attributes of the carpet structure, including resistance against delamination of the carpet's secondary textile backing, must be maintained.

### SUMMARY OF THE INVENTION

The invention is directed to a process for preparation of a tufted polyamide-type fiber carpet comprising: providing a primary backing tufted with yarn comprised of at least 85% by weight of fibers selected from the group nylon fibers, wool fibers, and blends thereof, the tufted primary backing having a carpet side and an opposite back side; providing a molten polymer adhesive on the back side of the tufted primary backing, the polymer adhesive consisting of at least 85% by weight of one or more ethylene copolymers each comprised of 50 to 95 weight % of ethylene, and 5-50 weight % of at least one comonomer selected from the group of esters and carboxylic acids; compressing the tufted primary backing and the molten polymer adhesive layer under a moving belt that applies a pressure of at least 1 N/cm² for a period of at least 5 seconds during which time the polymer adhesive remains in a molten state; and then cooling the molten polymer adhesive to a temperature below the melting point of the molten adhesive. A secondary backing may be placed over the molten polymer adhesive on the back of the primary backing before or after the primary backing and the molten polymer adhesive are compressed under the moving belt. The tufted primary backing with the molten polymer adhesive may also be introduced into a nip to further compress the molten polymer adhesive into the tufted primary backing.

According to one preferred embodiment of the process of the invention, the compressing of the tufted primary backing and the molten polymer adhesive layer under a moving belt includes compressing of the tufted primary backing and the molten polymer adhesive layer between a moving belt and a rotating heated drum with an outer heated surface, wherein the heated drum has a diameter of from 1 to 3 meters, the outer heated surface of the drum and the moving belt travel at substantially the same linear speed in the range of 10 to 30 m/minute, and the surface of the drum is heated to a temperature within the range of 130 to 180° C.

According to another preferred embodiment of the process of the invention, the compressing of the tufted primary backing, the molten polymer adhesive layer, and the secondary backing under a moving belt comprises the compressing of tufted primary backing, the molten polymer adhesive layer and the secondary backing between two moving belts heated to a temperature within the range of 130 to 200° C. over a distance of 3 to 10 meters, and wherein the two moving belts travel at substantially the same linear speed in the range of 10 to 30 m/minute.

### BRIEF DESCRIPTION OF THE DRAWINGS

FIG. 1 is a cross-sectional view of a portion of a carpet made by the process of the invention.

FIG. 2 is a schematic view showing a preferred embodiment of the process of the invention.

FIG. 3 is a schematic view showing another preferred embodiment of the process of the invention.

### DEFINITIONS

The term “polymer” as used herein, generally includes but is not limited to, homopolymers, copolymers (such as for example, block, graft, random and alternating copolymers), terpolymers, and blends and modifications thereof. Furthermore, unless otherwise specifically limited, the term “polymer” shall include all possible geometrical configurations of the material. These configurations include, but are not limited to isotactic, syndiotactic and random symmetries.

The term “polyolefin” as used herein, is intended to mean any of a series of largely saturated polymeric hydrocarbons composed only of carbon and hydrogen. Typical polyolefins include, but are not limited to, polyethylene, polypropylene, polymethylpentene and various combinations of the monomers ethylene, propylene, and methylpentene.

The term “polypropylene” as used herein is intended to encompass not only homopolymers of propylene, but also copolymers wherein at least 85% of the recurring units are propylene units.

The term “nylon” as used herein is intended to encompass polymer comprising at least 85% of one or more of the known aliphatic polyamide polymers and copolymers commonly referred to as nylons, including polyamide 6, polyamide 66, polyamide 610, polyamide 612, polyamide 11, polyamide 12, polyamide 1212, and polyamide 6/66. Methods for producing these aliphatic polyamides are well known, and include the condensation of equimolar amounts of saturated dicarboxylic acid containing 4 to 12 carbon atoms with a diamine, in which the diamine contains 4 to 14 carbon atoms, as for example the polymerization of hexamethylene diamine and adipic acid [nylon 66] or the polymerization of caprolactum [nylon 6].

The term “nonwoven” as used herein means a structure of individual fibers or threads that are positioned in a random manner to form a planar material without an identifiable pattern, as in a knitted woven fabric.

### Test Methods

Carpet Fiber Retention was measured according to ISO Method DIS 12951-1 (also known as the Lisson Tretrad test) (which has also been designated as European Standard EN-1963), which is incorporated herein by reference. This test method measures the wear durability of a tufted carpet under conditions intended to simulate the abrasive wear common in high traffic commercial environments. The test apparatus consists of a Lisson Tretrad machine which comprises a bed plate on which a carpet sample is supported under tension, a Tretrad assembly that applies abrasive force to the carpet sample, and a vacuum cleaning system that collects carpet fibers that come loose during testing. The Tretrad assembly includes a wheel with four legs spaced at 90° angles from each other. A disk shaped foot covered with a rubber sole is attached to the end of each leg. During testing, the feet press down on the carpet sample with a vertical force of 150 Newtons and are moved along the carpet by a lever arm as the wheel is continuously rolled back and forth over the carpet. The linear speed of the Tretrad arm is 0.28 m/sec. and the peripheral speed of the feet is 20% greater than the linear speed, leading to slippage of the feet on the test specimen. Suction nozzles follow the feet to collect any fibers abraded out of the carpet. The abraded fibers are weighed and a fiber retention index I_{TR} is calculated by the following formula:

I_{TR}=0.19{M_{AP}[100−M_{RV}]/100}^{1/2}, where

M_{AP} is the mass of pile per unit area above the primary backing in g/m²

M_{RV} is the percent fiber weight lost, which is determined by the formula:

M_{RV}=(M_{V}/M_{AP})100, where

M_{V}=the weight of the fibers collected from the carpet (in grams) divided by the tested area of carpet (in square meters)

Melt index was determined according to ASTM D-1238@190° C. with a weight of 2.16 Kg and is reported without units.

Tensile strength was determined by DIN 53504-85 or S2/ISO 37 T2, which is hereby incorporated by reference. In the test a 0.3 cm by 7.5 cm dumbbell sample (as described in 53504-85 or S2/ISO 37 T2) was clamped at opposite ends of the sample. The clamps were attached 5 cm from each other on the sample. The sample was pulled steadily at a speed of 200 mm/min until the sample broke. The stress at break was recorded in MPa as the breaking tensile strength. The elongation at break was recorded as a percent.

Adhesion was measured by the following Nylon Adhesion Test Method. A 2 mm thick polyamide 6,6 plate was prepared using a press at a temperature of 270° C. Polyamide 6,6, in granular form was introduced into the press and was preheated under a pressure of 5 Bars for 5 minutes. The pressure was increased to 100 Bars for a period of 2 minutes. The plate was cooled for about 8 minutes (while the pressure of 100 Bars was maintained) and it was then removed from the press. A 2 mm thick plate of the adhesive polymer was prepared by the same procedure, but at a temperature of 150° C. Adhesive polymer in granular form was introduced into the press and was preheated under a pressure of 5 Bars for 5 minutes. The pressure was then increased to 100 Bars for a period of 2 minutes. The plate was cooled for about 8 minutes (while the pressure of 100 Bars was maintained) and it was then removed from the press. The polyamide 6,6 plate and the adhesive polymer plate were then pressed between the jaws of a press maintained at 150° C. for the jaw in contact with PA66 and room temperature for the jaw in contact with the adhesive polymer and under a pressure of 20 Bars for 1 minute to adhere the two plates to each other. The adhered plates were left in the press and cooled to approximately room temperature before being removed from the press. One cm by 15 cm strips of this structure were then prepared and the adhesive polymer was delaminated manually from the PA66 over a length of 3 cm. The adhesive section was then removed from the polyamide 6,6 section by clamping the manually delaminated ends of the sample in the jaws of a tensile testing equipment. The clamps were attached 2 cm from each other. Delamination was done steadily at a speed of 50 mm/min. The force required to delaminate the adhesive from the polyamide 6,6 was measured and reported in units of N/cm.

Visual Aspect was rated, as prescribed in the norm DIN EN 1963-part A, using the following scale:

1. Failure. Extreme structure change in wear areas, such as primary backing visible due to missing yarn tufts, more than three cut pile or loops missing in test area (for loop carpets), hairy loose filaments with length≧15 mm observed.

2. Satisfactory. Suitable for residential purposes. Moderate structure change in wear area, such as some loss of yarn twist (Saxony) and or loss of bulkiness, hairy loose filaments with length of 5 to 15 mm, some bristle in carpet loops (for cut and loop carpets).

3. Good. Suitable for normal traffic commercial purposes. Small structure change in wear area, such as minor loss of yarn twist, hairy loose filaments with length≦5 mm, almost no damage of tufted pile surfaces. Surface integrity fully maintained.

4. Very Good. Suitable for high traffic commercial purposes. Very little structure change in wear area, surface integrity fully maintained.

### DETAILED DESCRIPTION

The process of the invention is used to produce a carpet having a polyamide-type face yarn, such as nylon, wool, or blends thereof. The polyamide-type yarn is tufted into a sheet of a primary backing material by a conventional tufting process. A thermoplastic adhesive is applied to the portion of the tufts extending through the backside of the primary backing so as to lock the yarn fibers in place. As used herein, “fibers” refers to both continuous filament fibers and staple fibers. As shown in FIG. 1, a primary backing 10 is tufted with a face yarn 12. An adhesive 14 is applied to the backside of the tufted primary backing and a secondary backing 16 is preferably adhered to the adhesive 14. Preferably, the tufted carpet 20 is comprised of polyamide-type fiber yarn such as nylon or wool, tufted on a polyolefin spunbonded primary backing. More preferably, tufted carpet 20 has a cut pile, loop pile, or a combination of the two, and is comprised of nylon face yarn. A preferred carpet is made with ANTRON® nylon 66 yarn sold by E.I. du Pont de Nemours and Company (“DuPont”), and is tufted on a polypropylene spunbonded nonwoven primary backing, such as TYPAR® nonwoven sheet sold by DuPont.

According to the invention, a thermoplastic polymer adhesive is applied to the back of a tufted primary backing in a manner that penetrates the yarn tufts so as to contact most or all of the fibers in the tufts. The adhesive adheres to the polyamide-type fibers in the tufts and lock essentially all of the fibers in the tufts. The adhesive may also adhere to the secondary backing material that may be applied to the back side of the carpet over the adhesive. The polymer adhesive used in the carpet of the invention performs a number of different functions. First, the adhesive must be applied in a manner that allows the adhesive to impregnate the fiber networks of the tufts and contact the overwhelming majority of the fibers in the tufts. The adhesive, in its molten state, must penetrate into the fiber network of the portion of the carpet tufts extending through the backside to the primary backing. Preferably, the adhesive is compatible with the fibers of the carpet such that the adhesive readily wets the fibers of the polyamide-type carpet tufts. Second, the adhesive adheres to the polyamide-type fibers in the carpet tufts. This adhesion is needed to keep the carpet fibers locked in the carpet by the adhesive binder when the carpet is subjected to abrasive wear. Preferably, the adhesive chemically bonds to the polyamide-type fibers of the carpet tufts. Third, the adhesive, in its solidified state, must firmly hold onto the fibers of the carpet when the fibers are pulled from the carpet during abrasive wear.

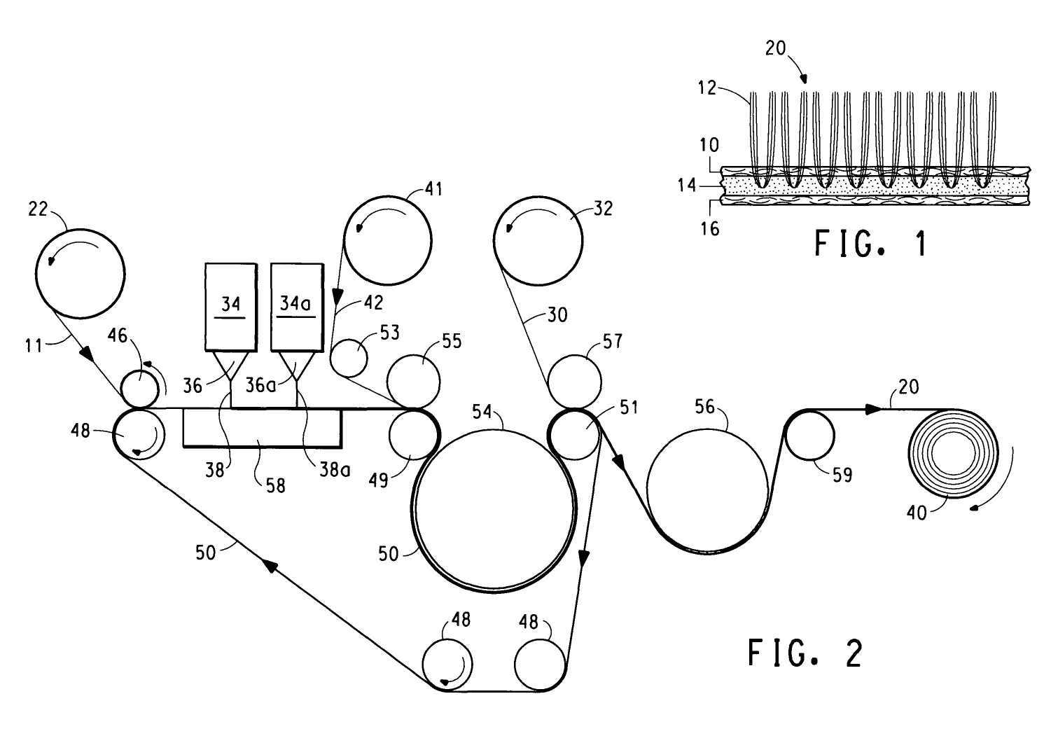

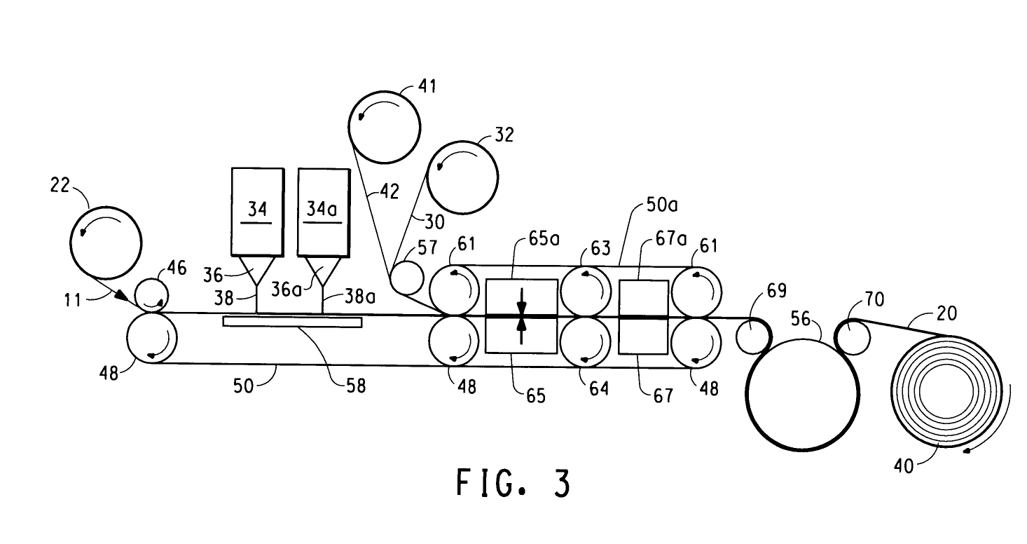

Adhesion to a sufficient percentage of the fibers in the tufts in the carpet so as to hold the fibers in place is achieved through selection of the adhesive polymer and through control of application process conditions. The carpet making process of the invention uses a laminator in conjunction with a pressure belt that helps press the molten polymer adhesive into contact with the fibers of the portions of the face yarn passing through the backside of the primary carpet backing. A laminator with a large belted heated drum is shown in FIG. 2, and a laminator with an extended belted flat bed is shown in FIG. 3.

In the laminator with a belted drum shown in FIG. 2, a tufted primary backing is first coated with one or more polymer adhesives and then pressed against a large heated drum so as to drive the adhesive into the yarn on the backside of the primary backing before a secondary backing is applied over the adhesive and the carpet is cooled to solidify the polymer adhesive. A tufted primary backing 11 comprised of a polyamide-type face fiber yarn on a primary backing is unwound from roll 22 and passed between a guide roller 46 and a belt roller 48. The carpet face yarn is directed downward such that the carpet face yarn comes into contact with the belt 50 that is moving on the belt roller 48. The belt is preferably made of a high strength fabric coated with a non-sticking polymer such as Teflon® PTFE. The belt 50 is maintained under a tension sufficient to press the carpet against the drum 54 with a pressure of at least 1 N/cm² and more preferably of from 2 to 10 N/cm². The belt moves at a speed of 1 to 100 meters per minute, and more preferably of 10 to 30 meters per minute. The specially formulated thermoplastic adhesive polymer described above is melted in an extruder 34, such as a screw extruder, and fed through a heated die 36 to form a uniform layer of molten adhesive 38. The molten adhesive layer 38 is applied on the backside of the primary backing 11 at an application rate sufficient to cover the backside of the tufted primary backing and penetrate into the void spaces between the fibers of the portions to the face yarn tufts passing through the back side of the primary backing of the carpet. The distance from the exit of the die 36 to the point where the adhesive melt contacts the backside of the primary backing is preferably less than 5 cm, and is more preferably less than 1 cm, such that a uniform film of the polymer adhesive can be applied over the full width of the primary backing. A second extruder 34a with a second heated die 36a may be used to apply a layer of a more viscous and less costly adhesive 38a over the adhesive layer 38. The second adhesive layer does not need to penetrate the yarn tufts, but instead, it serves to fill in the valleys on the backside of the tufted primary backing which helps the belt to press the less viscous adhesive 38 into the yarn tufts. During the extrusion step, the table 58 supports the belt 50 and the tufted primary backing so that the distance between the primary carpet backing and the extruder die openings is kept constant.

The belt 50 and the adhesive coated primary backing 11 are directed by a transfer roller 49, which may be heated, onto a large diameter heated drum 54. Drum 54 preferably has a diameter of from 1 to 3 meters, has a metal surface coated with an anti-stick polymer, and is heated by steam or hot oil such that the surface of the drum 54 is preferably maintained at a temperature of 130 to 180° C., depending upon the melting point of the thermoplastic adhesive polymer. The tension on the belt 50 exerts a radial force against the face yarn side of the tufted primary backing 11, and the primary backing 11 is in turn pressed against the heated drum 54 such that molten polymer adhesive coated on the backside of the of the primary carpet backing is gradually pressed into nearly all of the void spaces within the portions of the yarn tufts extending through the backside of the primary carpet backing. If it is desired to incorporate a reinforcing grid into the carpet for added dimensional stability, the reinforcing grid material may be applied over the molten adhesive layer before or after the laminated primary backing is contacted with the heated drum. In FIG. 2, a reinforcing grid 42 is shown being applied over the molten adhesive by the guide rollers 53 and 55 just before the primary backing is pressed against the heated drum 54. The reinforcing grid 42 may be a reinforcing scrim material such as a fiberglass grid, a polyester grid, or any other material that provides good dimensional stability at a temperature up to 90° C. Preferably, the reinforcing grid 42 is a glass fiber grid with a basis weight of about 60 g/m² made with a 340 dTex glass fiber warp yarn and a 680 dTex glass fiber weft yarn.

A stripper roll 51 removes the tufted primary backing 11 and molten polymer adhesive coating from the heated drum 54. A secondary backing material 30, such as a woven, nonwoven or needlefelt fabric, or a thermoplastic sheet, is fed from roll 32 and around a roller 57 that presses the secondary backing against the adhesive-coated back side of the tufted primary backing 11. The carpet, which is now comprised of at least the tufted primary backing 11, the adhesive polymer 38 and the secondary backing 30, is removed from the rotating belt 50 and transferred to a chill roll 56. The chill roll 56 sets the adhesive polymer before the carpet is removed from the chill roll by a stripper roller 59. The setting of the polymer adhesive is controlled by the selection of the size and temperature of the chill roll, the wrap angle on the chill roll, and the line speed. Preferably, the chill roll is maintained at a temperature in the range of 4 to 40° C., and more preferably in the range of 8 to 25° C. Cooling can be increased through the use of multiple chill rolls. By the time the finished carpet comes off the chill roll, the polymer adhesive should have cooled sufficiently such that the fibers in the carpet tufts are firmly locked (into the tufts). The finished carpet 20 is finally wound up on roll 40. Those skilled in the art will recognize that the process described can be augmented with optional equipment such as belt heaters, additional cooling rolls, and applicators for the addition of additives to the adhesive polymer.

In an alternative embodiment of the invention, the process shown in FIG. 2 may be modified such that the secondary backing material 30 is applied over the molten adhesive layer 38 before the tufted primary backing 11 passes between the rollers 49 and 55 and around the drum 54 of FIG. 2. With such an arrangement, the secondary backing material is interposed between the molten polymer and the surface of the drum 54 such that the possible sticking of the molten polymer to the drum is avoided.

Another belt laminator for producing carpet according to the process of the invention has a belted flat bed, and is shown in FIG. 3. With this flat bed laminator, the back side of a tufted primary backing is first coated with one or more polymer adhesives and a secondary backing is subsequently fed through the flat bed where the carpet is pressed between heated moving belts before being cooled to solidify the polymer adhesive. A tufted primary backing 11 comprised of a polyamide-type face fiber yarn on a primary backing is unwound from roll 22 and passed between a guide roller 46 and a belt roller 48. The belt 50 is maintained under light tension and it preferably moves at a speed of 10 to 30 meters per minute. The thermoplastic adhesive polymer is melted in an extruder 34, such as a screw extruder, and fed through a heated die 36 to form a uniform layer of molten adhesive 38. The molten adhesive layer 38 is applied over the back side of the primary backing of the tufted carpet 11 at an application rate sufficient to cover the backside of the tufted primary backing and to penetrate into the void spaces between the fibers of the portions to the face yarn tufts passing through the back side of the primary backing of the carpet. The distance from the exit of the die 36 to the point where the adhesive melt contacts the backside of the primary backing is preferably less than 5 cm, and is more preferably less than 1 cm, such that a uniform film of the polymer adhesive can be applied over the full width of the primary backing. A second extruder 34a with a second heated die 36a may be used to apply a layer of a more viscous and less costly adhesive 38a over the adhesive layer 38. This second adhesive layer does not need to penetrate the yarn tufts, but instead, it serves to fill in valleys on the backside of the tufted primary backing which helps the belts to press the less viscous adhesive polymer layer 38 into the yarn tufts. The table 58 supports the belt 50 and the back of the tufted primary backing so that the distance between the primary carpet backing and the extruder dies is kept constant.

A secondary backing material 30, such as a woven, nonwoven or needlefelt fabric, or a thermoplastic sheet, is fed from roll 32 and around a guide roller 57 to a belt roller 61 that presses the secondary backing against the adhesive-coated back side of the tufted primary backing 11. Optionally, a reinforcing grid may be incorporated into the carpet between the secondary backing and the molten adhesive layer to improve the dimensional stability of the carpet. A reinforcing grid 42 may be fed from the roll 41 and brought into contact with the secondary backing by the guide roller 57 just before a belt roller 61 presses the secondary backing and reinforcing grid against the adhesive-coated back side of the tufted primary backing 11. The reinforcing grid 42 may be any of the reinforcing scrim materials discussed above. The roll 61 and the roll 48 are preferably biased toward each other with a constant pressure of about 10 N/cm² so as to force the tufted primary backing coated with molten polymer adhesive and the secondary backing into engagement with each other.

The carpet is next passed through a flat bed laminator having a heated pressure section, a nip, and a cooling section. The flat bed laminator has belts 50 and 50a that are set with a gap between them that is approximately 40 to 80 percent of the total thickness of tufted primary backing and the secondary backing. The gap between the belts 50 and 50a is maintained by the spring-loaded heat and pressure application modules 65 and 65a which apply a surface pressure to the carpet of from 0.5 to 10 N/cm². The belts 50 and 50a are preferably made of high strength fabric coated with a non-sticking polymer such as Teflon® polytetrafluoroethylene. The belts 50 and 50a are heated to a temperature that allows the molten polymer to remain in molten form, and is preferably in the range of 100 to 175° C., depending on the melting point of the adhesive polymer, and more preferably between 120 and 150° C. As the carpet is squeezed in the gap between the belts 50 and 50a, the molten polymer is gradually forced into the void spaces within the portion of the yarn tufts passing through the backside of the primary carpet backing. Preferably the belts 50 and 50a are heated by resistance heaters, but they may alternatively be heated by other means such as hot air or steam. The belts move at a linear speed timed to allow the adhesive polymer to be pressed into most of the void spaces between the fibers in the portion of the yarn tufts extending through the backside of the primary backing before entering the nip formed between the rolls 63 and 64. Preferably the belts 50 and 50a each move at substantially the same speed. The carpet is preferably squeezed between the belts 50 and 50a for a period of from 5 to 15 seconds before passing between the rolls 63 and 64.

The space between the rolls 63 and 64 is preferably maintained at about 80% of the gap between the belts 50 and 50a. Rolls 63 and 64 preferably have metal or hard rubber surfaces. The nip formed between the rolls 63 and 64 serves to drive the molten adhesive into substantially all of the void spaces between the fibers in the portion of the yarn tufts extending through the backside of the primary backing. Cooling units 67 and 67a cool the belts and carpet after they exit the nip formed between the rolls 63 and 64. The cooling units 67 and 67a may be spring-loaded water-chilled modules having a smooth non-sticking surface that contacts the moving belt or they may alternatively comprise air fans that cool the belts and the carpet. The cooling units 67 and 67a cool the carpet to a temperature that allows the adhesive polymers to begin to solidify before exiting the flat bed laminator. The final belt rolls 48 and 61 remove the belt from the carpet before the carpet is directed by a guide roll 69 onto the chill roll 56. The chill roll 56 sets the adhesive before the carpet is removed from the chill roll by another guide roll 70. The setting of the polymer adhesive is controlled by the selection of the size and temperature of the chill roll, the wrap angle on the chill roll, and the line speed. Preferably, the chill roll is maintained at a temperature in the range of 4 to 40° C., and more preferably in the range of 8 to 25° C. By the time the finished carpet comes off the chill roll, the polymer adhesive should have cooled sufficiently such that the fibers in the carpet tufts are firmly locked. The finished carpet 20 is subsequently wound up on roll 40. Those skilled in the art will recognize that the process described can be augmented with optional equipment such as additional belt heaters, nip rolls, cooling rolls, corona treatments, and applicators for the addition of additives to the adhesive polymer.

In an alternative process for making the carpet of the invention, the polymer adhesive described above can be spread in fine powder form directly on the backside of the tufted primary backing by means of one or several powdering units used in place of the die extruders. The powdered adhesive is then melted by radiant heaters such that the polymer adhesive is spread in molten form over the backside of the tufted primary backing before the molten polymer is pressed into the carpet yarn tufts by the processes shown in FIGS. 2 and 3.

In another alternative process for making the carpet of the invention, the polymer adhesive described above can be spread in fine powder form directly on one side of the secondary backing material by means of one or several powdering units used in place of the die extruders. The powdered adhesive is then melted by radiant heaters such that the polymer adhesive is spread in molten form over the one side of the secondary backing which side is then brought into contact with the backside of the tufted primary backing. The molten polymer is then pressed into the carpet yarn tufts by any of the processes shown in FIGS. 2 and 3.

In yet another alternative process, the specially formulated polymer adhesive can be spread, in fine powder form, on a moving belt with a non-stick surface and subsequently melted with radiant heaters. The melted polymer is then transferred from the belt, at the exit of the radiant heaters, by means of a nip roll onto the backside of the primary tufted backing. This alternative process can also be used to replace the die extruders of the processes shown in FIGS. 2 and 3.

The polymer adhesive preferably has a viscosity and an affinity for the carpet fibers that enable it to contact and wet a substantial majority of the fibers in the tufts. The viscosity of the molten adhesive is controlled through the polymerization process used to produce the adhesive and by adjusting the temperature at which the adhesive is extruded during the carpet making process. It has also been found that the wetting property of the adhesive for the polyamide-type fibers of the carpet face yarn can be improved by including a polar component in the adhesive polymer. The preferred thermoplastic polymer adhesive used in the process of the invention to bind the fibers of the tufts of the carpet of the invention is a resin from the group of ethylene copolymers and terpolymers comprising 50-95 weight % ethylene and 5-50 weight % of one or more comonomers which are either esters or carboxylic acids. Examples of suitable ester comonomers are vinyl acetate, butyl acrylate or methyl acrylate. Examples of desired carboxylic acids are methacrylic acid and acrylic acid. The polymer adhesive used in the process of the invention may also comprise blends of such ethylene copolymers and terpolymers. For example, an adhesive that is a blend of a first copolymer of ethylene and vinyl acetate and a second copolymer of ethylene and methacrylic acid has been formulated that functions well as the thermoplastic polymer adhesive for the carpet of the invention. The ethylene/vinyl acetate component is believed to have a degree of polarity that improves wetting of the adhesive for polyamide-type fibers, and the ethylene/methacrylic acid component of the adhesive is believed to provide chemical bonding between the adhesive and the polyamide-type fibers. Another preferred thermoplastic adhesive is a terpolymer containing 50-98 weight % ethylene, 1-25 weight % butyl acrylate, and 1-25 weight % methacrylic acid. More preferably, this terpolymer is from the family of terpolymers containing 60-90 weight % ethylene, 5-20% butyl acrylate and 5-20% methacrylic acid. In this terpolymer, the butyl acrylate is believed to contribute the polarity needed for good wetting of the polyamide-type fibers and the methacrylic acid component is believed to chemically bond to the polyamide type fibers.

The ethylene copolymer or terpolymer polymer adhesives adhere well to the polyamide-type fibers of tufts of the carpet. The ethylene copolymer or terpolymer polymer adhesive has a good tenacity in its solidified state so as to not break and release fibers when the fibers of the carpet tufts are pulled during abrasive wear. It has been found that lower viscosity adhesives can be more readily pressed into the void spaces between the fibers in the yarn tufts. Preferred adhesives have a melt index greater than 150, according to ASTM D-1238@190° C. with a weight of 2.16 Kg, but higher viscosity adhesives (with lower melt indexes) can also be used if the higher viscosity is compensated for by increasing the pressure of the belt against the carpet and/or by increasing the amount of time that the carpet is subjected to the belt pressure. More preferably, the polymer adhesive has a melt index in the range of 200 to 800, and most preferably in the range of 400 to 600 according to ASTM D-1238@190 ° C. with a weight of 2.16 Kg. However, when a low viscosity polymer adhesive with a melt index greater than 150 is used, it is difficult to apply a uniform layer of the adhesive to the backside of the primary backing because such low viscosity polymers tend to run rather than forming uniform films. It has been found that such low viscosity polymer adhesive can still be uniformly applied to the backside of the primary backing if the distance that the molten adhesive travels from the extrusion die before contacting the primary backing is kept at less than 5 cm, and more preferably at less than 1 cm.

The adhesive application temperature will vary with the adhesive formulation and the composition of the carpet face yarn, but with the ethylene copolymer and terpolymer adhesives described above, the extrusion temperature is preferably in the range of 150 to 325° C. The adhesive application rate will vary with the adhesive, the application conditions and the composition of the tufted primary backing. For most carpet systems and adhesives, application rates of at least 150 g/m² and more optimally from 250 g/m² to 600 g/m² will be effective. In the processes described below, the adhesive polymer is pressed into the portion of the yarn tufts extending through the backside of the primary backing so as to drive the molten polymer adhesive into contact with the maximum number of fibers in the carpet tufts before the adhesive cools. Preferably, the adhesive will penetrate into at least 60% of the void spaces within the fiber network of the tufts that are on the backside of the primary backing. More preferably, the adhesive will penetrate at least 80% of the void spaces within the fiber network of the tufts that are on the backside of the primary backing.

Preferably, the secondary backing 16 of the carpet shown in FIG. 1 is a needlefelt fabric comprised of fibers of polypropylene, polyethylene terephthalate or a combination of the two. One preferred needlefelt is a 5 mm thick fleece with a basis weight of about 550 g/m² comprised of 80% fine polypropylene fibers (˜2 dtex) and 20% polyethylene terephthalate fibers having a melt temperature that is lower than the melt temperature of the polypropylene fibers. Another preferred secondary backing is a sheet of rubber or thermoplastic polymer, such as a foam rubber. A polymer sheet that can be used as the secondary backing is KELDAX® sheet material, sold by DuPont, which contributes added weight, noise damping, flame retardancy, and antislip properties to a finished carpet, while also giving the carpet a greater affinity for the glues commonly used for gluedown carpet installations. When the secondary backing is a thermoplastic sheet or foam, the secondary backing can be extruded simultaneously with the polymer adhesive.

The processes described above for producing the carpet of the invention consume considerably less space and energy than is the case with a conventional latex coating process. The carpets made by the process of the invention are latex-free and odorless. They are generally waterproof and they do not retain moisture which provides both hygienic and cleaning advantages, making such carpets ideal for hospital and nursing home use. In addition, the carpets made by the process of the invention can be recycled and they are easier to handle than conventional latex-based carpets due to their lower mass per unit area. Depending on the secondary backing utilized, the process of the invention can be used in the production of broadloom carpets, carpet tiles or automotive carpets. Carpets made by the process of the invention retain a very high proportion of their fibers under abrasive wear conditions. These carpets exhibit a Tretrad fiber retention index (I_{TR}) greater than the 1.7 (as is desirable for residential carpets), and even greater than the index of 3.0 (as is desirable for commercial carpets).

### EXAMPLES

In the following examples, tufted carpets were prepared.

### Example 1

In Example 1, a carpet was prepared using the flat bed laminator shown in FIG. 3. The carpet was a loop pile carpet with a face fiber weight of 690 g/m². The primary backing was a 108 g/m² polypropylene spunbonded nonwoven and the face yarn was a 1360 dTex BCF nylon 66 yarn.

The polymer adhesive was a terpolymer of ethylene with 10 weight % i-butyl acrylate, 10 weight % methacrylic acid, having a melt index of 400 according to ASTM D-1238 (@190° C. with a weight of 2.16 Kg). The polymer adhesive had an adhesion with nylon 6,6 of 11.6 N/10 mm and tensile strength of 6.0 MPa.

The tufted primary backing was deposited onto a moving belt with the face yarn side of the carpet facing down. The belt was traveling at 4 meters/min. The polymer adhesive was coated on the backside of the primary backing at a melt temperature of 230° C. and at a basis weight of about 2500 g/m², and was covered by a secondary backing. The secondary backing was a 5 mm thick needlefelt fleece with a basis weight of about 550 g/m² comprised of 100% fine (˜2 dtex) polyethylene terephthalate fibers fibers. The carpet was next passed through a flat bed laminator like that described above with regard to FIG. 3. The carpet first passed between a set of two belts that applied a surface pressure of about 2.5 N/cm² to the carpet. The belts of the laminator were heated to between 130 and 150° C. by resistance heating modules having flat surfaces that pressed against the back of the belts. The gap between the belts was set at 7 mm. At the end of a 3 m long heated section, the belts, with the carpet between them, passed through a nip that was maintained with a constant opening of 6 cm. The resulting pressure in the nip was 10 N/cm². The belts, with the carpet between them next continued into a cooling section where the belts passed between a series of spring-loaded water-chilled modules having a smooth non-sticking surface that pressed against the moving belts so as to maintain a gap of 7 mm between the belts. At the end of the 2 m long cooling section, the belts were removed from the carpet by two rollers. No addditional chill rolls were used.

The finished carpet was tested for fiber retention according to the Lisson Tretrad fiber retention test procedure. Upon completion of the Lisson Tretrad fiber retention test procedure, the visual aspect of the finished carpet was rated as category 4 (very good) according to DIN 1963A.

### Example 2

In Example 2, a carpet was prepared using the flat bed laminator shown in FIG. 3. The carpet was a level loop pile carpet with a face fiber weight of 460 g/m². The primary backing was a 108 g/m² polypropylene spunbonded nonwoven and the face yarn was a 1360 dTex BCF nylon 66 yarn.

The polymer adhesive was a terpolymer of ethylene with 10 weight % i-butyl acrylate, 10 weight % methacrylic acid, having a melt index of 400 according to ASTM D-1238 (@190° C. with a weight of 2.16 Kg). The polymer adhesive had an adhesion with nylon 6,6 of 11.6 N/10 mm and tensile strength of 6.0 MPa.

The tufted primary backing was unrolled from a supply roll onto a moving belt with the face yarn side of the carpet facing down. The belt was traveling at 4 meters/min. The polymer adhesive was coated on the backside of the primary backing at a melt temperature of 150° C. at a basis weight of about 2500 g/m², and was covered by a secondary backing. The secondary backing was a 3.5 mm thick needlefelt fleece with a basis weight of about 350 g/m² comprised of 100% fine (˜2 dtex) polyethylene terephthalate fibers. The carpet was next passed through a flat bed laminator like that described above with regard to FIG. 3. The carpet first passed between a set of two belts that applied a surface pressure of about 2.5 N/cm² to the carpet. The belts of the laminator were heated to 130 to 150° C. by resistance heating modules having flat surfaces that pressed against the back of the belts. The gap between the belts was set at 7 mm. At the end of a 3 m long heated section, the belts, with the carpet between them, passed through a nip that was maintained with a constant opening of 6 mm. The resulting pressure in the nip was about 10 N/cm². The belts, with the carpet between them next continued into a cooling section where the belts passed between a series of spring-loaded water-chilled modules having a smooth non-sticking surface that pressed against the moving belts so as to maintain a gap of 7 mm between the belts. At the end of the 2 m long cooling section, the belts were removed from the carpet by two rollers. No additional chill roll was used.

The finished carpet was tested for fiber retention according to the Lisson Tretrad fiber retention test procedure. Upon completion of the Lisson Tretrad fiber retention test procedure, the visual aspect of the finished carpet was rated as category 4 (very good) according to DIN 1963A.

1. A process for preparation of a tufted polyamide-type fiber carpet comprising
providing a primary backing tufted with yarn comprised of at least 85% by weight of fibers selected from the group nylon fibers, wool fibers, and blends thereof, said tufted primary backing having a carpet side and an opposite back side,
providing a molten polymer adhesive on the back side of the tufted primary backing, said polymer adhesive consisting of at least 85% by weight of one or more ethylene copolymers each comprised of 50 to 95 weight % of ethylene, and 5-50 weight % of at least one comonomer selected from the group of esters and carboxylic acids,
compressing said tufted primary backing and said molten polymer adhesive layer under a moving belt that applies a pressure of at least 1 N/cm² for a period of at least 5 seconds during which time the polymer adhesive remains in a molten state,
cooling said molten polymer adhesive to a temperature below the melting point of said molten adhesive.

2. The process of claim 1 wherein prior to compressing said tufted primary backing and molten polymer adhesive under a moving belt, a secondary backing is placed over the molten polymer adhesive on the back of the primary backing.

3. The process of claim 1 further comprising the step of introducing the tufted primary backing with the molten polymer adhesive into a nip and compressing molten polymer adhesive into said tufted primary backing in said nip.

4. The process of claim 1 wherein compressing said tufted primary backing and said molten polymer adhesive layer under a moving belt comprises compressing tufted primary backing and said molten polymer adhesive layer between a moving belt and a rotating heated drum with an outer heated surface, wherein the heated drum has a diameter of from 1 to 3 meters, the outer heated surface of the drum and the moving belt travel at substantially the same speed in the range of 10 to 30 m/minute, and the surface of the drum is heated to a temperature within the range of 130 to 180° C.

5. The process of claim 4 wherein the belt presses the primary backing against the heated drum with a pressure of from 2 to 10 N/cm².

6. The process of claim 2 wherein compressing said tufted primary backing, said molten polymer adhesive layer, and said secondary backing under a moving belt comprises the step of compressing tufted primary backing, said molten polymer adhesive layer and said secondary backing between two moving belts, wherein the moving belts are heated to a temperature within the range of 130 to 200° C. over a distance of 3 to 10 meters, and wherein the two moving belts travel at substantially the same speed in the range of 10 to 30 m/minute.

7. The process of claim 6 wherein the two moving belts squeeze the primary backing, the molten polymer adhesive and the secondary backing together under a pressure of from 2 to 10 N/cm².

8. The process of claim 1 wherein the extrusion temperature of the molten polymer adhesive is in the range of 150 to 325° C.

9. The process of claim 2 further comprising the step of introducing a reinforcing grid between the back side of the tufted primary backing and the secondary backing prior to compressing said tufted primary backing, said molten polymer adhesive layer, and said secondary backing in said nip.

10. The process of claim 1 wherein the comonomer selected from the group of esters and carboxylic acids consists of vinyl acetate, butyl acrylate, methyl acrylate, methacrylic acid, and acrylic acid.

11. The process of claim 10 wherein the polymer adhesive is a terpolymer containing 50-90 weight % ethylene, 5-20 weight % butyl acrylate, and 5-20 weight % methacrylic acid.

12. The process of claim 10 wherein at least 20 weight % of the polymer adhesive is a copolymer containing 50-95 weight % ethylene and 5-50 weight % metharcylic acid.

13. The process of claim 12 wherein at least 20 weight % of the polymer adhesive is a copolymer containing 50-95 weight % ethylene and 5-50 weight % vinyl acetate.

14. The process of claim 1 wherein the polymer adhesive has a melt index of at least 150 according to ASTM D-1238 @190° C. with a weight of 2.16 Kg.

15. The process of claim 14 wherein the polymer adhesive has a melt index in the range of 200 to 800 according to ASTM D-1238 @190° C. with a weight of 2.16 Kg.
